(19) United States
(12) Patent Application Publication
(10) Pub. No.: US 2020/0144882 A1
(43) Pub. Date: May 7, 2020

(54) ELECTRIC MACHINE WITH COMPRESSIBLE LAYER

(71) Applicant: Ford Global Technologies, LLC, Dearborn, MI (US)

(72) Inventors: Chun TANG, Canton, MI (US); Joel HETRICK, Ann Arbor, MI (US); Shailesh Shrikant KOZAREKAR, Novi, MI (US)

(21) Appl. No.: 16/179,184

(22) Filed: Nov. 2, 2018

(51) Int. Cl. H02K 1/30; H02K 1/18

(52) U.S. Cl. CPC H02K 1/30; H02K 15/14; H02K 1/185

(57) ABSTRACT

An electric machine includes a stator core, a cylindrical housing circumscribing the core, and an annular compressible layer. The annular compressible layer is received on the core and has an outer surface disposed against the housing. A diameter of the outer surface is larger than a diameter of an inner surface of the core to form an interference fit between the housing and the compressible layer.

### TECHNICAL FIELD

The is disclosure relates to electric machines, and more specifically to electric machines that include a compressible layer between a stator core and a housing to facilitate an interference fit between the housing and the stator core.

### BACKGROUND

Vehicles such as battery-electric vehicles and hybrid-electric vehicles contain a traction-battery assembly to act as an energy source for the vehicle. The traction battery may include components and systems to assist in managing vehicle performance and operations. The traction battery may also include high-voltage components, and an air or liquid thermal-management system to control the temperature of the battery. The traction battery is electrically connected to an electric machine that provides torque to driven wheels. Electric machines typically include a stator and a rotor that cooperate to convert electrical energy into mechanical motion or vice versa.

### SUMMARY

According to one embodiment, an electric machine includes a stator core, a cylindrical housing circumscribing the core, and an annular compressible layer. The annular compressible layer is received on the core and has an outer surface disposed against the housing. A diameter of the outer surface is larger than a diameter of an inner surface of the core to form an interference fit between the housing and the compressible layer.

According to another embodiment, an electric machine includes a stator core and a cylindrical housing circumscribing the core. The housing defines an inner circumferential surface. An annular sleeve is interposed between the core and the housing. The sleeve is received on the core and has an outer circumferential surface disposed against the inner surface. A diameter of the outer surface is larger than a diameter of the inner surface to form an interference fit between the housing and the sleeve.

According to yet another embodiment, an electric machine includes a stator core, a cylindrical housing circumscribing the core, and an annular sleeve interposed between the core and the housing. The sleeve includes arcuate segments circumferentially arranged around the stator core in a spaced relationship. An outer diameter of the sleeve is larger than an inner diameter of the housing to form an interference fit between the housing and the sleeve.

### BRIEF DESCRIPTION OF THE DRAWINGS

FIG. 1 is a schematic diagram of an electric machine.

FIG. 2 is a perspective view of a stator of the electric machine.

FIG. 3 is a perspective view of an annular compressible layer of the electric machine according to one embodiment.

FIG. 4 is an end view of an electric machine having a housing interference fit to a stator. Windings of the stator are omitted for illustrative purposes.

FIG. 5 is an exploded view of the electric machine of FIG. 4.

FIG. 6 is an end view of an electric machine having an annular compressible layer according to another embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

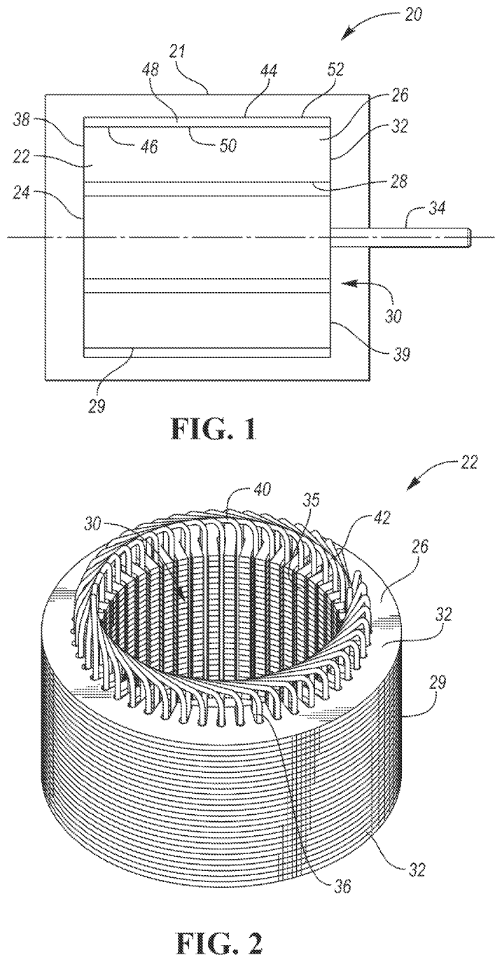

Referring to FIG. 1, an electric machine 20 may be used in a vehicle such as a fully electric vehicle or a hybrid-electric vehicle. The electric machine 20 may be referred to as an electric motor, a traction motor, a generator, or the like. The electric machine 20 may be a permanent magnet machine, an induction machine, or the like. In the illustrated embodiment, the electric machine 20 is a three-phase alternating current (AC) machine. The electric machine 20 is capable of acting as both a motor to propel the vehicle and as a generator such as during regenerative braking.

The electric machine 20 may be powered by a traction battery of the vehicle. The traction battery may provide a high-voltage direct current (DC) output from one or more battery-cell arrays, sometimes referred to as battery-cell stacks, within the traction battery. The battery-cell arrays may include one or more battery cells that convert stored chemical energy to electrical energy. The cells may include a housing, a positive electrode (cathode), and a negative electrode (anode). An electrolyte allows ions to move between the anode and cathode during discharge, and then return during recharge. Terminals allow current to flow out of the cells for use by the vehicle.

The traction battery may be electrically connected to one or more power electronics modules. The power electronics modules may be electrically connected to the electric machines 20 and may provide the ability to bi-directionally transfer electrical energy between the traction battery and the electric machine 20. For example, a typical traction battery may provide a DC voltage while the electric machine 20 may require a three-phase (AC) voltage. The power electronics module may include an inverter that converts the DC voltage to a three-phase AC voltage as required by the electric machine 20. In a regenerative mode, the power electronics module may convert the three-phase AC voltage from the electric machine 20 acting as a generator to the DC voltage required by the traction battery. While the electric machine 20 is described as a traction motor for a vehicle, this disclosure is not limited to any particular application. The electric machine 20, for example, may also be used in industrial equipment, electrical generation, and the like.

Referring to FIGS. 1 and 2, the electric machine 20 includes a housing 21 that encloses the stator 22 and the rotor 24. The stator 22 is fixed to the housing 21 and includes a cylindrical core 26 having an inner circumferential surface 28 that defines a hole 30 and an outer circumferential surface 29. The core 26 may be formed from a plurality of stacked laminations 32. The rotor 24 is supported for rotation within the hole 30. The rotor 24 may include windings or permanent magnets that interact with windings of the stator 22 to generate rotation of the rotor 24 when the electric machine 20 is energized. The rotor 24 may be supported on a driveshaft 34 that extends through the housing 21. The driveshaft 34 is configured to couple with a drivetrain of the vehicle.

The core 26 defines a plurality of teeth 35 extending radially inward. Adjacent teeth 35 cooperate to define slots 36 circumferentially arranged around the core 26. The slots 36 may be equally spaced around the circumference and extend axially from a first end 38 of the core 26 to a second end 39. A plurality of coil windings 40 are wrapped around the stator core 26 and are disposed within the slots 36. Portions of the wires generally extend in an axial direction through the slots 36. At the stator core ends 38, 39, the windings 40 bend to extend circumferentially around the top or bottom of the stator core 26 forming the end windings 42.

The housing 21 may be secured to the stator core 26 by an interference fit (press fit). The interference fit may be supplemented by fasteners or other joining means. An interference fit can be formed by inserting an inner component into an outer component having an inner diameter that is smaller than an outer diameter of the inner component. The tightness of an interference fit is based on the amount of interference (size difference between the inner and outer diameters). The electric machine 20 may interference fit the housing 21 to the stator 22. Interference fitting the housing directly onto the core, however, is problematic when the housing and the stator core are formed of different materials that have different coefficients of thermal expansion (CTE).

The stator core 26 is typically formed from steel whereas the housing 21 is typically formed of a lighter weight material such as aluminum. The CTE of aluminum is roughly double that of steel. This CTE difference causes the amount of interference between the steel core and the aluminum housing to change based on temperature. At high temperatures, the amount of interference is reduced due to the expansion of the housing relative to the core, and, at low temperatures, the amount of interference is increased due to the contraction of the aluminum housing relative the steel core.

Testing and simulation by Applicant has determined that a loss of interference can occur at the upper temperature range of a traction motor leading to release of the stator core from the housing, and excessive interference can occur at the lower temperature range of the traction motor leading to stator or housing damage. For example, the aluminum housing may crack due to excessive interference at lower temperatures.

This disclosure proposes to add a compressible layer 48 between the stator core 26 and the housing 21 so that a proper interference fit is maintained over the operating temperature range of the electric machine 20. The compressible layer 48 allows an initially tighter interference fit at room temperature so that proper interference is maintained at the upper temperatures of the operating range, and is compressible to prevent damage to the housing 21 or the stator core 26 at lower temperatures of the operating range. The compressible layer 48 may be formed of a material having a lower elastic modulus than the housing and/or the stator core. The compressible layer may be formed of a material having an elastic modulus between 0.1 to 6.5 gigapascals (GPA). Example materials include magnesium or polymers. The materials chosen for the compressible layer 48 may depend upon the materials of the stator core 26 and the housing 21. One suitable combination is to use a magnesium or polymer compressible layer with a steel core and an aluminum housing.

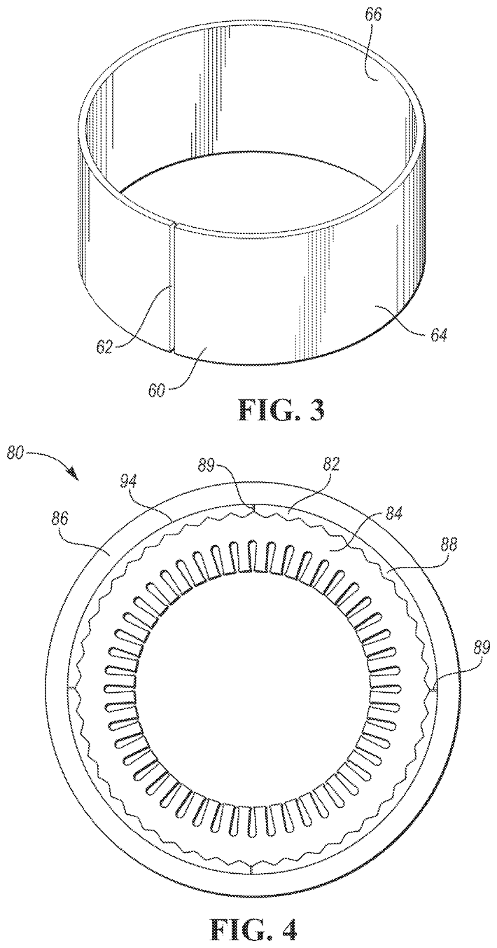

The compressible layer 48 may be annular to encircle the stator core 26. The compressible layer 48 may be formed of a single component or may include multiple pieces that are circumferentially arranged around the outer surface 29 of the stator core. The compressible layer 48 includes an inner circumferential surface 49 having an inner diameter 50 disposed on the outer diameter 29 of the stator core and an outer circumferential surface 52 that engages with an inner surface 44 of the housing 21. The outer surface 52 has an outer diameter that is larger than the inner diameter of surface 44 to form an interference fit between the housing 21 and the compressible layer 48. In one embodiment, the compressible layer 48 is a sleeve. The sleeve may be a single piece as shown in FIG. 3 or may include multiple arcuate segments circumferentially arranged around the stator core 26 in a spaced relationship as shown in FIG. 4.

Referring to FIG. 3, a sleeve 60 is designed to be interposed between a stator core and a housing to act as a compressible layer to facilitate interference fit between the stator core and the housing. The sleeve 60 includes a split 62 extending along a length of the sleeve to facilitate radial expansion and contraction of the sleeve 60. The split 62 extends through a thickness of sleeve. The sleeve 60 includes an outer diameter 64 and an inner diameter 66. The inner diameter 66 may be sized to substantially match the outer diameter of the stator core. The outer diameter 64 is sized to be larger than the inner diameter of the housing so that an interference fit is formed between the sleeve 60 and the housing when installed. The length of the sleeve 60 may match the length of the stator core.

In the illustrated embodiment, the sleeve 60 has smooth inner and outer surfaces, however, in other embodiments, the sleeve 60 may include connection features for interconnecting with the housing or the stator core. For example, one of the core and the sleeve includes a projection and the other of the core and the sleeve includes a receptacle that receives the projection therein. In some embodiments, multiple projections and receptacles may be used to secure the sleeve and core. The connection features aid in retaining the sleeve to the core during installation of the housing as well as retain the sleeve in place during the contraction and expansion of the housing and the core due to temperature changes. In some embodiments, the connection features may be between the housing and the sleeve rather than between the sleeve and the core.

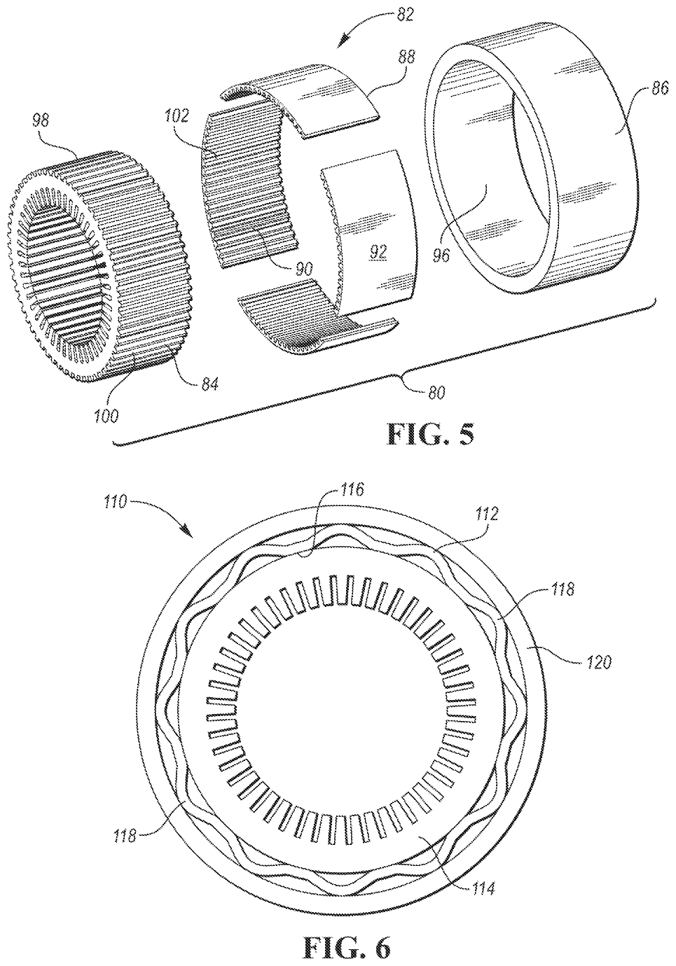

Referring to FIGS. 4 and 5, an electric machine 80 includes a multi-segment sleeve (compressible layer) 82 that is retained to the stator core 84 by connection features. The stator core 84 is similar to the stator core 26 except for the connection features. The housing 86 may be similar to the housing 21. The sleeve 82 includes a plurality of arcuate segments 88 that are circumferentially arranged around the stator core 84 such that the segments 88 are spaced apart to define gaps 89. Splitting the sleeve into multiple segments may aid in assembly of the electric machine and the gaps 89 may provide clearance for the sleeves to radially expand and contract. Each of the segments 88 includes an inner surface 90 that is seated on the stator core 84 and an outer surface 92 disposed against the housing 86. The outer surfaces 92 cooperate to form a discontinuous outer surface 94 of the sleeve 82. The outer diameter of the sleeve 82 is larger than the inner diameter 96 of the housing 86 to form an interference fit.

In the illustrated embodiment, the connection features are teeth 100 defined on the outer surface 98 of the stator core 84 and teeth 102 defined on the inner surfaces 90 of the segments 88. The teeth 100 and 102 mesh with each other to secure the segments 88 onto the stator core 84. In other embodiments, the meshing teeth may be replaced with projections and receptacles. While illustrated in conjunction with connection features, the multi-segment sleeve 82 may be used in electric machines that do not include connection features.

Referring to FIG. 6, the compressible layer may be a resilient member that has a high degree of resiliency as compared to the above described sleeve. For example, an electric machine 110 may include a corrugated spring 112 disposed between the stator core 114 and a housing 113. The spring 112 may be formed of spring steel. The corrugated spring 112 is configured to expand and contract primarily in the radial direction (R). The corrugated spring 112 includes radially inner contacts 116 seated on an outer surface 117 of the core 114 and radially outer contacts 118 seated on an inner surface of the housing 120. The corrugated spring 112 can be compressed to move the inner and outer contacts 116, 118 towards each other to reduce the outer diameter 119 of the spring 112, and can be expanded to move the inner and outer contacts 116, 118 away from each other to increase the outer diameter 119 of the spring 112.

A resting outer diameter 119 of the corrugated spring 112 (measured between diametrically opposing outer contacts 118) is larger than the inner diameter of the housing 120 so that the corrugated spring 112 is compressed when installed. The compression of the spring 112 creates sufficient friction between the inner and outer contacts 116, 118 and the stator core 114 and the housing 120, respectively, to secure the housing 120 to the stator core 114 similar to the interference fit of the above-described embodiments. The spring 112 is configured to expand to maintain frictional engagement when the housing expands relative to the stator core 114 at higher temperatures, and is configured to contract to prevent damage when the housing 120 contracts relative to the stator core 114 at lower temperatures.

The spring 112 may be tubular to axially extend along a substantial portion of the stator core 114. In some embodiments, the corrugated spring 112 may be as long as the stator core 114. Alternatively, multiple, shorter springs may be used.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An electric machine comprising:
a stator core;
a cylindrical housing circumscribing the core and defining an inner circumferential surface; and
an annular sleeve interposed between the core and the housing, the sleeve being received on the core and having an outer circumferential surface disposed against the inner surface, wherein a diameter of the outer surface is larger than a diameter of the inner surface to form an interference fit between the housing and the sleeve.

2. The electric machine of claim 1, wherein the sleeve is formed from a material having a lower elastic modulus than the housing.

3. The electric machine of claim 1, wherein the sleeve, the core, and the housing are formed of different materials.

4. The electric machine of claim 1, wherein the sleeve is formed of magnesium or a polymer.

5. The electric machine of claim 1, wherein the sleeve is formed of or a polymer.

6. The electric machine of claim 1, wherein the sleeve is formed of multiple arcuate segments that are circumferentially arranged around the stator core in a spaced relationship so that gaps are defined between adjacent ones of the arcuate segments.

7. The electric machine of claim 1, wherein the core defines an outwardly extending projection that is disposed in a receptacle defined in the sleeve.

8. The electric machine of claim 1, wherein the sleeve defines an outwardly extending projection that is disposed in a receptacle defined in the housing.

9. The electric machine of claim 1, wherein the core has an outer circumferential surface defining teeth, and the sleeve has an inner circumferential surface defining teeth that mate with the teeth of the core.

10. An electric machine comprising:
a stator core;
a cylindrical housing circumscribing the core; and
an annular compressible layer received on the core and having an outer surface disposed against the housing, wherein a diameter of the outer surface is larger than a diameter of an inner surface of the core to form an interference fit between the housing and the compressible layer.

11. The electric machine of claim 10, wherein an elastic modulus of the compressible layer is less than an elastic modulus of the housing.

12. The electric machine of claim 10, wherein the annular compressible layer is formed of cooper, magnesium, or a polymer.

13. The electric machine of claim 10, wherein the annular compressible layer is a sleeve.

14. The electric machine of claim 10, wherein the annular compressible layer includes a plurality of arcuate segments that are circumferentially arranged around the stator core in a spaced relationship so that gaps are defined between adjacent ones of the arcuate segments.

15. The electric machine of claim 10, wherein the compressible layer is a corrugated spring.

16. An electric machine comprising:
a stator core;
a cylindrical housing circumscribing the core; and
an annular sleeve interposed between the core and the housing and including arcuate segments circumferentially arranged around the stator core in a spaced relationship, wherein an outer diameter of the sleeve is larger than an inner diameter of the housing to form an interference fit between the housing and the sleeve.

17. The electric machine of claim 16, wherein the sleeve has a lower elastic modulus than the housing.

18. The electric machine of claim 16, wherein the stator core, the sleeve, and the cylindrical housing are all formed of different materials.

19. The electric machine of claim 16, wherein the core defines one of a projection and a receptacle and the sleeve defines the other of the projection and the receptacle, wherein the projection is received in the receptacle.

20. The electric machine of claim 16 further comprising a rotor supported for rotation within the stator core.
